(19) United States
(12) Patent Application Publication
(10) Pub. No.: US 2006/0092026 A1
(43) Pub. Date: May 4, 2006

(54) Method of creating an RFID tag with substantially protected rigid electronic component

(76) Inventors: Daniel P. Lawrence, Ann Arbor, MI (US); Jennifer Rigney, Ann Arbor, MI (US); Daniel Gibson, Westland, MI (US)

Correspondence Address: HARNESS, DICKEY & PIERCE, P.L.C., P.O. BOX 828, BLOOMFIELD HILLS, MI, 48303, US

(21) Appl. No.: 10/979,875

(22) Filed: Nov. 2, 2004

(51) Int. Cl. G08B 13/14

(52) U.S. Cl. 340/572.7; 340/572.5

(57) ABSTRACT

An electronic assembly and method for making the same includes a flexible substrate and a protective layer arranged adjacent to one side of the substrate. The protective layer has a first thickness and defines at least one hole. A first electrical component has a second thickness that is less than or equal to the first thickness. The first electrical component is received in the hole in the protective layer.

### FIELD OF THE INVENTION

The present invention relates to printing and/or assembly of electronic components on a printing web.

### BACKGROUND OF THE INVENTION

Integrated circuits (ICs) are the basic building blocks that are used to create electronic devices. Continuous improvements in IC process and design technologies have led to smaller, more complex, and more reliable electronic devices at a lower cost per function. As performance has increased and size and cost have decreased, the use of ICs has expanded significantly.

For example, radio frequency identification (RFID) technology incorporates the use of electromagnetic or electrostatic radio frequency (RF) coupling to an IC. Traditional forms of identification such as barcodes, cards, badges, tags, and labels have been widely used to identify items such as access passes, parcels, luggage, tickets, and currencies. However, these forms of identification may not protect items from theft, misplacement, or counterfeit, nor do they allow “touch-free” tracking.

More secure identification forms such as RFID technology are an attractive alternative to traditional identification and tracking. RFID does not require physical contact and is not dependent on line-of-sight for identification. RFID technology is widely used today at lower frequencies, such as 13.56 MHz, in security access and animal identification applications. Higher-frequency RFID systems ranging between 850 MHz and 2.5 GHz have recently gained acceptance and are being used in vehicular tracking and toll collecting applications and in manufacturing and distribution applications.

An RFID system includes at least three major components. A transponder component, which usually includes an IC that is embedded within a tag or the like, is electronically programmed with unique identification and/or other information about the item. The smaller the transponder component, the easier it is to attach to a host such as a product, a label, or other objects. A transceiver component contains a decoder and communicates with transponders that are within range. Multiple transceivers can be used to extend the range capabilities of RFID. An antenna component is connected to the transponder.

In business establishments that use RFID technology to monitor for shoplifting, transceivers are commonly placed near store exits. Each product contains a transponder that is placed within the packaging. Unless the transponder that is associated with a product is deactivated, the transponder will emit a RF signal. The transceiver receives the RF signal and triggers an alarm. A growing number of industries are using or have plans to use RFID technology in the near future. However, current manufacturing processes limit the speed of manufacture and the cost reduction of mass-producing RFID transponders.

With reference to FIGS. 1 and 2, exemplary RFID tags 10 and 12 according to the prior art are shown. In general, RFID tags 10A and 10B (collectively 10) each include an IC or other rigid electrical component 20, an antenna 22, a substrate 24, pressure sensitive adhesive 26 and a release liner 28. A conductive adhesive 29 is used to attach the IC 20 to the antenna 22 and provides an electrical connection therebetween. The RFID tag 10 may include a potting compound 30 or other material arranged over the IC 20 for protection as shown in FIG. 1. Alternatively the RFID tag 12 may incorporate a laminate layer 32 that is attached over the antenna 22 and IC 20 as shown in FIG. 2. When printing RFID tags 10 in large quantities, it is typical to roll a group of RFID tags 10 into a roll 34 shown in FIG. 3A. A radial cross section of the roll 34 is shown in FIG. 3B. As can be appreciated, the difference in rigidity between integrated circuit 20 and the ductile properties of the conductive adhesive 29, antenna 22 and substrate 24 can lead to mechanical fatigue and/or failure of the RFID tags 10, 12. Similar failures may occur when the RFID tags are singulated and stacked.

### SUMMARY OF THE INVENTION

An electronic assembly and method for making the same includes a flexible substrate and a protective layer arranged adjacent to one side of the substrate. The protective layer has a first thickness and defines at least one hole. A first electrical component has a second thickness that is less than or equal to the first thickness. The first electrical component is received in the hole in the protective layer.

According to other features, the electronic structure further includes a second electrical component that is attached and/or printed on the substrate. The first electrical component is attached to the second electrical component. A conductive adhesive attaches the first electrical component to the second electrical component. In one form, the protective layer includes double-sided tape. In another form, the protective layer includes pressure sensitive adhesive and a release liner.

In some embodiments, the first electrical component includes an RFID integrated circuit and the second electrical component includes an antenna. The flexible substrate may include a printing web.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a first exemplary integrated electronic assembly according to prior art;

FIG. 2 illustrates a second exemplary integrated electronic assembly according to prior art;

FIG. 3A illustrates a roll of integrated electronic assemblies according to prior art;

FIG. 3B is a cross section of the integrated electronic assemblies of FIG. 3A according to prior art;

FIG. 4 illustrates an exemplary integrated electronic assembly shown in a pre-installed position according to the present teachings;

FIG. 5 illustrates the integrated electronic assembly of FIG. 4 shown in an installation position;

FIG. 6 illustrates the integrated electronic assembly of FIG. 5 shown in an installed position;

FIG. 7 illustrates assembly steps for making the integrated electronic assembly of FIG. 4;

FIG. 8A illustrates a roll of integrated electronic assemblies according to the present teachings; and

FIG. 8B is a cross sectional view of integrated electronic assemblies of FIG. 8A according to the present teachings.

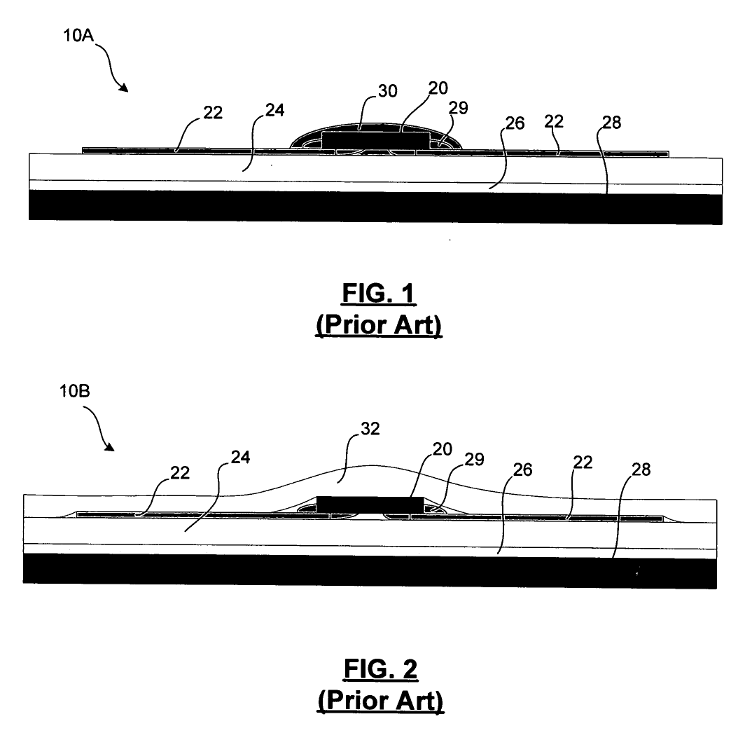

### DETAILED DESCRIPTION OF THE PREFERRED EMBODIMENTS

The following description of the preferred embodiment(s) is merely exemplary in nature and is in no way intended to limit the invention, its application, or uses. While present invention is being described in conjunction with RFID technology, it can also be applied to other rigid electronic devices that are attached to printing webs.

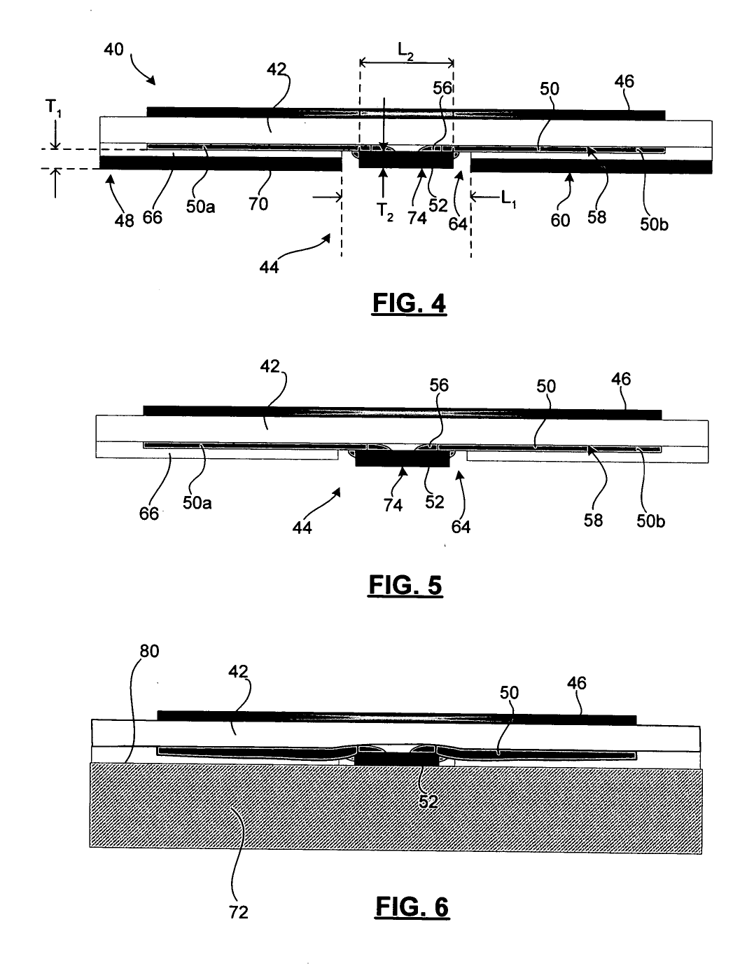

Referring now to FIG. 4, a sectional view of an electronic assembly 40 is shown to generally include a substrate 42, an electronic structure 44, a graphics layer 46 and a protective layer 48. The substrate 42 can be any packaging material, such as plastic, Mylar, cardboard, paper, or another suitable material known to those skilled in the art, that is conducive to the brand manufacturer's specifications and the printing and/or attaching process. The electronic structure 44 can include printed portions that are printed using conductive ink and/or attached portions that are attached to the substrate 42. If printed, the electronic structure 44 can be printed using transparent conductive ink and/or with colored conductive ink.

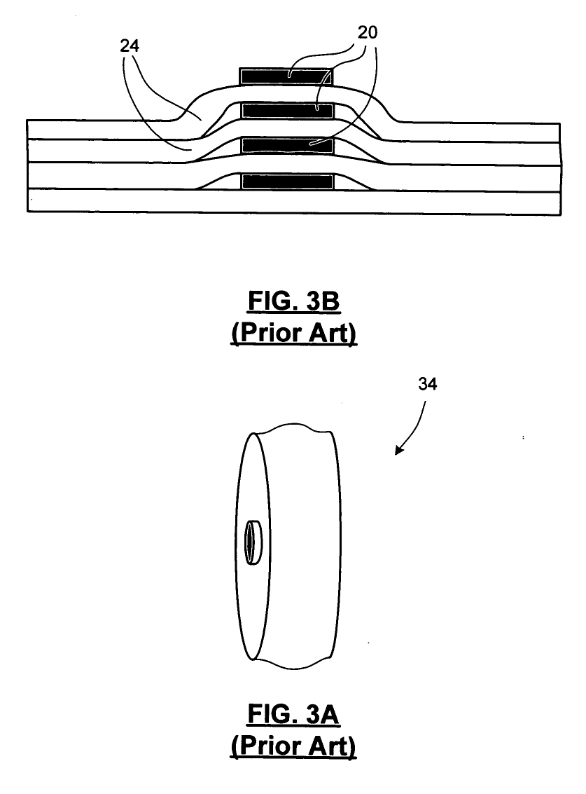

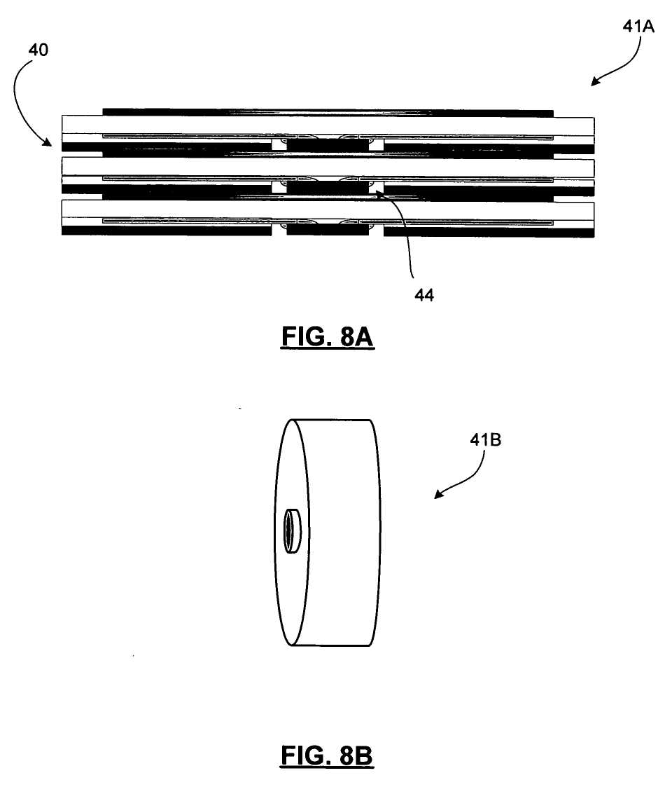

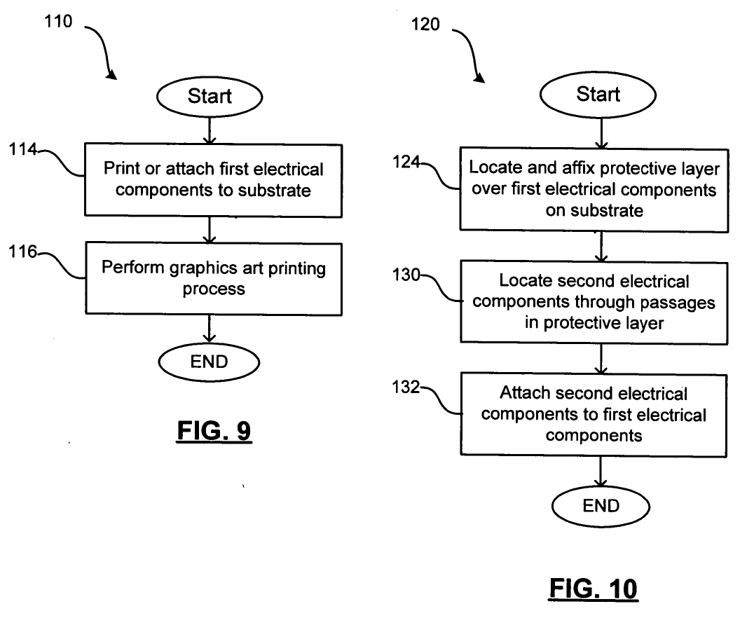

The electronic structure 44 can be any suitable electronic structure. In one embodiment shown in FIGS. 3-8A, the electronic structure 44 includes a printed RFID antenna 50 and an attached RFID IC 52. The RFID IC 52 may be attached to the substrate 42 and/or the antenna 50, for example, with a conductive adhesive 56. The graphic art printing layer 46 is printed onto the substrate 42.

With continued reference now to FIG. 4, the electronic assembly 40 will be described in greater detail. The antenna 50 of the electronic structure 44 includes a pair of antenna attachment points 50a, 50b printed onto a first surface 58 of the substrate 42. The RFID IC 52 is attached to the pair of antenna attachment points 50a, 50b with the conductive adhesive 56. The protective layer 48 is attached to the antenna 50 and presents a substantially planar outer surface 60. A gap 64 having a length L₁ is defined in the protective layer 48 for accommodating a length L₂ of the RFID IC 52.

The protective layer 48 according to some embodiments comprises an adhesive sheet 66 and a release liner 70. The adhesive sheet 66 is attached to the antenna 50 and the release liner 70 is attached to the adhesive sheet 66. In one form, the adhesive sheet 66 comprises a pressure sensitive adhesive. The adhesive sheet 66 may be printed onto the antenna 50 and/or substrate 42. Alternatively, the protective layer 48 may comprise double sided tape. Still other variations are contemplated. As can be appreciated, the release liner 70 may be selectively removed from the adhesive sheet 66. Then, the adhesive sheet 66 is attached to an object, such as a package or product 72 (FIG. 6).

The protective layer 48 defines a first thickness T₁ from an outer surface of the antenna 50 to the outer surface 60 of the protective layer 48. The RFID IC 52 defines a second thickness T₂ that is preferably less than the first thickness T₁. The RFID IC 52 lies in a protected area that is recessed relative to the protective layer 48. As a result, stress and/or strain is reduced and/or eliminated on the electronic structure 44 and the electronic assembly 40. In addition, while the adhesive layer 66 is shown to be approximately one-half the thickness of the release liner 70, any suitable proportions may be implemented. Moreover, those skilled in the art will appreciate that the protective layer 48 may comprise the adhesive layer 66 exclusively.

With continued reference to FIG. 4 and further reference to FIGS. 5 and 6, installation of the electronic assembly 40 onto a surface 80 of the object 72 will now be described. At the outset, the release liner 70 is removed from the adhesive sheet 66 as shown in FIG. 5. Next, the adhesive sheet 66 is pressed onto the surface 80 of the object 72 as shown in FIG. 6. The RFID IC 52 is protected between the substrate 42 and the destination object 72. The antenna 50 is shown deflected partially into the substrate 42 FIG. 6. In the installed position, the graphics layer 46 is presented in a substantially planar manner.

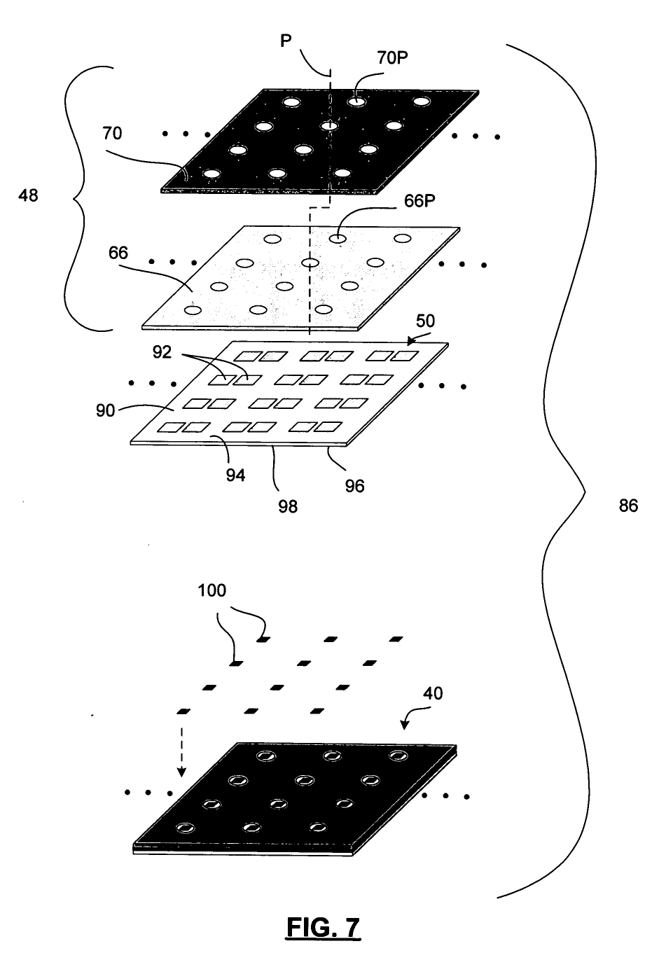

Referring now to FIG. 7, an automated manufacturing process 86 of the electronic assemblies 40 is shown. First electrical components 92 are printed and/or attached on a first surface 94 of a printing web 90. A graphics layer 96 may be printed on a second surface 98 of the printing web 90. In some embodiments, the first electrical components 92 define the first and second antenna attachment points 50a and 50b. In FIG. 7, four antennas 50 are printed across the printing web 90. However, additional and/or fewer antennas 50 can be printed if desired.

The protective layer 48 and the second electrical components 100 are then attached. The protective layer 48 may include the adhesive sheet 66 and release liner 70 (as shown), which are located onto the respective first electrical components 92 such that respective passages 66P and 70P align to create a common passage P. As was described above, the adhesive sheet 66 may be pressure sensitive adhesive that is applied in any suitable manner and then the release liner 70 is applied over the pressure sensitive adhesive. Kiss cutting that is registered to where the chip is located can also be performed. Alternatively, double-sided tape can be used. The second electrical components 100 are located through the common passages P in the protective layer 48 and are attached to the first electrical components 92. In some embodiments the second electrical components 100 include a series of ICs that are inserted through the common passages P and attached across antenna attachment points 50a, 50b.

The second electrical components 100 may be attached to the first electrical components 92 by conductive adhesive (such as adhesive 56, illustrated in FIG. 4). The conductive adhesive may be applied to adjacent sides of each antenna attachment points 50a, 50b (FIG. 4) before the application of the RFID ICs 52. In some embodiments, conductive adhesive may be applied to the second electrical component 100 instead of and/or in addition to the first electrical component 92. The second electrical components 100 to be applied to each component on the printing web 90 may come in bulk on a roll or a web.

Those skilled in the art can now appreciate from the foregoing description that the broad teachings of the current invention can be implemented in a variety of forms. For example while the protective layer 48 has been described herein as having adhesive properties on an outer surface, the protective layer 48 may alternatively be void of adhesive properties. In this regard, the electronic assembly may be attached or otherwise retained in a secure position with an object by other methods while still maintaining the IC 52 in a nested relationship with the protective layer 48. Therefore, while this invention has been described in connection with particular examples thereof, the true scope of the invention should not be so limited since other modifications will become apparent to the skilled practitioner upon a study of the drawings, the specification and the following claims.

What is claimed is:

1. An electronic assembly comprising:
a flexible substrate;
a protective layer that is arranged adjacent to one side of said substrate, that has a first thickness and that defines at least one hole; and
a first electrical component that has a second thickness that is less than or equal to said first thickness and that is received in said hole in said protective layer.

2. The electronic assembly of claim 1 wherein said electronic structure further includes a second electrical component that is at least one of attached to and/or printed on said substrate, wherein said first electrical component is attached to said second electrical component.

3. The electronic assembly of claim 2 further comprising conductive adhesive that attaches said first electrical component to said second electrical component.

4. The electronic assembly of claim 2 wherein said protective layer includes double-sided tape.

5. The electronic assembly of claim 1 wherein said protective layer includes pressure sensitive adhesive and a release liner.

6. The electronic assembly of claim 1 further comprising a graphics layer at least one of attached to and/or printed on an opposite side of said substrate.

7. The electronic assembly of claim 1 wherein said flexible substrate comprises a printing web.

8. A system comprising the electronic assembly of claim 5 and further comprising an object, wherein said release liner is removed from said electronic assembly and said pressure sensitive adhesive is used to attach said electronic assembly to said object.

9. The electronic assembly of claim 2 wherein said second electrical component includes an antenna and said first electrical component includes an RFID integrated circuit.

10. The electric assembly of claim 1 wherein said first electrical component includes an integrated circuit.

11. The electrical assembly of claim 1 wherein said flexible substrate is a printing web and further comprising a plurality of said first components that are received in a plurality of said holes and wherein said printing web is rolled after said first electrical components and said protective layer are attached to said printing web.

12. An electronic assembly, comprising:
a printing web;
first electrical components printed on said printing web;
a protective layer that is attached to at least one of said printing web and said first electrical components and that defines holes therein; and
second rigid electrical components that are attached to said first electrical components in said holes;
wherein said protective layer has a first thickness that is greater than or equal to a second thickness of said second rigid electrical component.

13. The electronic assembly of claim 12 further comprising conductive adhesive that attaches said first electrical components to said second electrical components.

14. The electronic assembly of claim 12 wherein said protective layer includes double-sided tape.

15. The electronic assembly of claim 12 wherein said protective layer includes pressure sensitive adhesive and a release liner.

16. The electronic assembly of claim 12 further comprising graphics at least one of attached to and/or printed on an opposite side of said printing web.

17. The electronic assembly of claim 12 wherein said second electrical components include antennas and said first electrical components include RFID integrated circuits.

18. The electric assembly of claim 12 wherein said first electrical component includes an integrated circuit.

19. The electrical assembly of claim 12 wherein said printing web is rolled after said first and second electrical components and said protective layer are attached to said printing web.

20. A method of attaching an integrated circuit to a printing web, comprising:
providing a continuous printing web defining a substrate;
forming holes in a protective layer that has a first thickness;
attaching said protective layer to said substrate; and
attaching first electrical components having a second thickness to said substrate in said holes, wherein said first thickness is greater than or equal to said second thickness.

21. The method of claim 20 further comprising at least one of attaching and/or printing second electrical components on said substrate.

22. The method of claim 21 wherein attaching said first electrical components includes attaching said first electrical components to said second electrical components.

23. The method of claim 21 further comprising using conductive adhesive to attach said first electrical components to said second electrical components.

24. The method of claim 21 wherein said second electrical components comprise an antenna.

25. The method of claim 20 wherein attaching said protective layer comprises attaching a pressure sensitive adhesive to said substrate and a release liner to said pressure sensitive adhesive.
